(19) United States
(12) Patent Application Publication
(10) Pub. No.: US 2024/0291659 A1
(43) Pub. Date: Aug. 29, 2024

(54) Tokenized Credential Verification System

(71) Applicant: Authenticating. Com, LLC, Santa Monica, CA (US)

(72) Inventor: Steven Brandon Ward, Palm Beach Gardens, FL (US)

(21) Appl. No.: 18/586,201

(22) Filed: Feb. 23, 2024

Related U.S. Application Data
(60) Provisional application No. 63/528,792, filed on Jul. 25, 2023.
(60) Provisional application No. 63/486,696, filed on Feb. 24, 2023.

(51) Int. Cl. H04L 9/32; G06F 40/40; H04L 9/00

(52) U.S. Cl. CPC H04L 9/3213; G06F 40/40; H04L 9/3218; H04L 9/50

(57) ABSTRACT

A tokenized identity and credential verification system is disclosed. A coded, e.g., color-coded, symbol-coded, shape-coded, etc., token for identity and credential verification may provide details about verified information about the identity and credentials. Verified credentials may include licenses, degrees, employment history, professional affiliations, etc. Verified identities may include personal historical information, such as addresses, automobile color, automobile year, make, and model, business associations, phone numbers, etc. Each may receive a token or digital badge of a certain code. Codes may represent a verification status. For example, the token may be assigned one of many colors corresponding to the status of the credentials, such as active, in renewal, expired, etc. The token may be distributed in a blockchain where the token may not be deleted or modified.

### CROSS-REFERENCE TO RELATED APPLICATIONS

This application claims the benefit of the filing date of U.S. Provisional Patent Application No. 63/528,792 filed Jul. 25, 2023, and U.S. Provisional Patent Application No. 63/496,696 filed Feb. 24, 2023, the disclosure of which is hereby incorporated herein by reference.

### BACKGROUND

When a user attempts to log in to a computing resource, such as a network, device, or application, the computing resource may ask to verify the identity of the user. Verification options may include knowledge-based quizzes, photo identification forensic analysis, passwords, biometrics, and multi-factor authentication, as examples. Users typically do not have a choice in what verification options the computing resource utilizes to verify the identity of the user. When issues arise during verification, measures taken to remediate the issue may also be prone to errors. For instance, remediation measures may be hampered by communication delays, language barriers, and/or a need to provide an excessive amount of personal identification information, which a user may be hesitant to provide or not have readily available to provide. Issues may also arise, for example, when a user provides a photo for identification that is damaged, dirty, worn, or torn for initial verification since the computing resource cannot accurately discern the user's identity from such a damaged, dirty worn, or torn photo. Issues may further arise when the user has little to no online digital footprint, such that the computing resource is hampered to generate a personal knowledge quiz. Even if the computing resource generates a personal knowledge quiz the user cannot access their identification if the user cannot remember the correct answers to the questions asked.

Verification may be utilized for authenticating the credentials of an entity, such as an individual, business, agency, etc. Credentials typically indicate an entity's achievements and qualifications. For instance, an individual may have credentials indicating their academic qualifications and career achievements. Such credentials add credibility to statements, attestations, actions, and/or claims made by the entity associated with the credentials. For instance, an individual will typically assume a diagnosis from a medical professional having a Ph.D. credential is more accurate than a diagnosis from a person without a Ph.D. credential. However, some entities may claim to have credentials that they have not obtained or otherwise earned, i.e., false credentials, to mislead others. For instance, an individual receiving a diagnosis from a person having a false Ph.D. credential will typically assume the diagnosis is correct, although the person offering the diagnosis does not have a Ph.D. credential. Verification of an entity's credentials would detect such false credentials. However, verifying credentials may be time-consuming and difficult, as the information needed to verify credentials may be difficult to obtain.

### BRIEF SUMMARY

Aspects of the disclosure are directed to a tokenized identity and credentials verification system. The system may generate a coded token, e.g., color-coded, symbol-coded, etc., that indicates the identity and credentials of a user after verifying the information associated with the identity and credentials. A coded token may be linked to information about the identity and credentials that have been verified. Such information may include the verifications that were performed and the evidence used for the verification. The system may utilize machine learning for handling errors, exceptions, and/or failures in verifying the identity and/or credentials of a user.

The system may utilize a chatbot to decipher input data, adhere to work designations, and engage the user conversationally to assist them in identity and credentials verification, such as for account creation, account recovery, updating credentials information, and/or consent capture. The chatbot can utilize natural language processing and/or natural language understanding by parsing input language.

The system may utilize a taxonomy to generate the coded tokens. The taxonomy may provide an overview of the verification status. The system may also automatically collect data from official licensing, certification, professional, and/or educational databases to identify verifiable information from the collected data.

An aspect of the disclosure provides a method for generating an identity and credential verification token. The method comprises: providing, by one or more processors, one or more verification options to a user device for verifying at least one of an identity or one or more credentials of a user; receiving, by the one or more processors, data associated with responses to the one or more verification options; receiving, by the one or more processors, data associated with information for verifying the responses to the one or more verification options; verifying, by the one or more processors, the responses by comparing the data associated with the responses to the one or more verification options with the data associated with the information for verifying the responses; and generating, by the one or more processors, the identity and credential verification token based on coding the verified information using a coded digital badge, in response to verifying the responses.

Another aspect of the disclosure provides a system comprising one or more processors and one or more storage devices coupled to the one or more processors and storing instructions that, when executed by the one or more processors, cause the one or more processors to perform the method comprising: providing one or more verification options to a user device for verifying at least one of an identity or one or more credentials of a user; receiving data associated with responses to the one or more verification options; receiving data associated with information for verifying the responses to the one or more verification options; verifying the responses by comparing the data associated with the responses to the one or more verification options with the data associated with the information for verifying the responses; and generating the identity and credential verification token based on coding the verified information using a coded digital badge, in response to verifying the responses.

Yet another aspect of the disclosure provides a non-transitory computer-readable medium storing instructions that, when executed by one or more processes, cause the one or more processors to perform the method comprising: providing one or more verification options to a user device for verifying at least one of an identity or one or more credentials of a user; receiving data associated with responses to the one or more verification options; receiving data associated with information for verifying the responses to the one or more verification options; verifying the responses by comparing the data associated with the responses to the one or more verification options with the data associated with the information for verifying the responses; and generating the identity and credential verification token based on coding the verified information using a coded digital badge, in response to verifying the responses.

The above and other aspects of the disclosure can include one or more of the following features. In some examples, aspects of the disclosure provide for all of the following features in combination.

In an example, the method further comprises providing, by the one or more processors, information indicating a purpose for verifying the identity or credentials of the user on the identity and credential verification token.

In yet another example, the responses are verified when a difference between the data associated with the responses to the one or more verification options and the data associated with the information for verifying the responses is within a pre-configured threshold range of similarity.

In yet another example, the method further comprises determining, by the one or more processors, accuracy of the data associated with the responses to the one or more verification options based on historical data of the user.

In yet another example, the method further comprises outputting, by the one or more processors, a verification confirmation to the user in response to generating the identity and credential verification token.

In yet another example, wherein the identity and credential verification token comprises the coded digital badge displaying a status of at least one of the identity or the one or more credentials of the user.

In yet another example, the method further comprises determining, by the one or more processors, the responses cannot be verified; and outputting, by the one or more processors, a notification in response to determining the responses cannot be verified.

In yet another example, the method further comprises determining, by the one or more processors, the identity and credentials verification token is fraudulent; and flagging, by the one or more processors, the identity and credentials verification token, in response to determining the identity or credentials is fraudulent.

In yet another example, wherein the one or more credentials are related to at least one of occupational licenses, professional certifications, employment verification, or education verification.

In yet another example, wherein receiving the data associated with information for verifying the responses further comprises automatically collecting the data associated with information for verifying the responses from at least one of licensing certification or educational databases.

In yet another example, wherein verifying the data further comprises using a conversational machine learning model to assist the user with verifying the responses through natural language processing.

In yet another example, wherein generating the credential verification token further comprises generating different shapes for the credential verification token based on levels of taxonomy.

In yet another example, the method further comprises distributing, by the one or more processors, the identity and credential verification token in a blockchain.

In yet another example, wherein the one or more verification options include knowledge-based quizzes, photo identification forensic analysis, or multi-factor authentication.

### BRIEF DESCRIPTION OF THE DRAWINGS

FIG. 1 depicts a block diagram of an example tokenized identity and credential verification system according to aspects of the disclosure.

FIG. 2 depicts a block diagram of an example environment for implementing a tokenized identity and credential verification system according to aspects of the disclosure.

FIG. 3 depicts a block diagram illustrating an example blockchain blocks according to aspects of the disclosure.

FIG. 4A depicts a diagram illustrating an example credential verification token according to aspects of the disclosure.

FIG. 4B depicts diagrams illustrating example credential verification tokens according to aspects of the disclosure.

FIG. 4C depicts diagrams illustrating an example identity verification token according to aspects of the disclosure.

FIG. 5 depicts a block diagram illustrating example taxonomy structures according to aspects of the disclosure.

FIG. 6 depicts diagrams illustrating various shapes of credentials verification tokens according to aspects of the disclosure.

FIG. 7 depicts a flow diagram of an example process for generating credentials verification tokens according to aspects of the disclosure.

FIG. 8 depicts a flow diagram of an example process for the automatic identity verification process according to aspects of the disclosure.

### DETAILED DESCRIPTION

The technology generally relates to tokenized identity and credential verification using machine learning. Identity verification may be used for account creation, account recovery, and/or consent capture. Credential verification may be used to add credibility to statements, attestations, actions, and/or assertions, etc. made by an individual that is associated with credentials. A coded, e.g., color-coded, symbol-coded, shape-coded, etc., taxonomy for identity and credential verification may provide details respectively about verified identities and/or credentials. Codes may represent a verification status for credentials. For example, a token may be assigned one of many colors corresponding to the status of the credentials, such as active, in renewal, expired, etc. A user's identity may be verified using techniques such as social security number (SSN) trace, knowledge-based quizzes, photo identification forensic analysis, barcode data extraction, passport machine readable zone (MRZ) decoding, global watch list check, face and hand gesture recognition, thumb/fingerprint analysis, two-step verification with one-time passcodes sent over short message service (SMS) or email, card verification value/address verification service (CVV/AVS) credit/debit card verification, Internet protocol (IP) address lookup, reverse phone number lookups, etc. Verified credentials may include licenses, degrees, employment history, professional affiliations, etc. The coded token may be distributed in a blockchain where the token may not be deleted or modified.

Additionally, the tokens may be linked to information related to the identities and credentials that have been verified and the status of the identities and credentials. For example, the tokens may be assigned one of many colors corresponding to the status of the identities and credentials such as active, in renewal, expired, to be updated, to be further verified, etc. For example, a red token for an active nursing license may be linked to the verified credentials and information related to the credentials including when the nursing license was issued, the name of the licensing authority, the license number, and the license expiration date. Similarly, a red token for a user's biometric identification such as a fingerprint may indicate that the user's fingerprint needs to be scanned to enhance the security when the user logs into a website. The tokens may also include information related to verification methods and evidence that has been used for the verification. For example, the tokens may provide information about a licensing authority database that has been searched and information about the verified features of a physical license such as a license number, a verifiable seal, and/or the issue date. In the example related to the user's fingerprints, the token may record the information as to when the user's fingerprints were scanned and updated.

According to some examples, the identity and credentials verification process may include mapping the identity and/or credentials to a taxonomy with numerous levels of taxa, e.g., eight levels, ten levels, fifty levels, or more or fewer identities or credentials. For example, the eight levels of taxa may include domain, kingdom, phylum, class, order, family, genus, and species. The mapped identities and/or credentials may be used to generate the tokens.

The system can further include conversational machine learning to assist the user with verifying their identity and credentials through natural language processing and/or understanding.

According to some other examples, the tokens may be generated for multimodal biometric authentication. Multimodal biometric authentication may refer to using two or more physiological or behavioral characteristics to identify an individual. Such characteristics may include the individual's fingerprint, face recognition, iris or retina, voice, etc. Multimodal biometric authentication may involve different integration models such as multi-biometric fusion and multi-biometric serial assessment. Multi-biometric fusion models may combine scores corresponding to the accuracy of each biometric into a single score. Multi-biometric serial assessment models may be used to verify an individual through multiple successive authentication steps.

Multimodal biometric authentication can be implemented using multiple short-lived cryptographic keys derived from various biometric information in a layered passkey authentication system. For example, different passkeys may be derived for different biometric information (e.g. fingerprint, iris, retina, voice, etc.). The above passkeys may be regularly regenerated via decentralized key stores or key-ring protocols. The generated passkeys may be transient keys that are only temporarily valid to hinder cryptanalysis attacks. Each passkey may be layered to formalize multi-factor authentication systems. Each passkey may be persistently re-encrypted when the individual updates the biometric information (e.g. rescan iris/retina, voice, face, etc.)

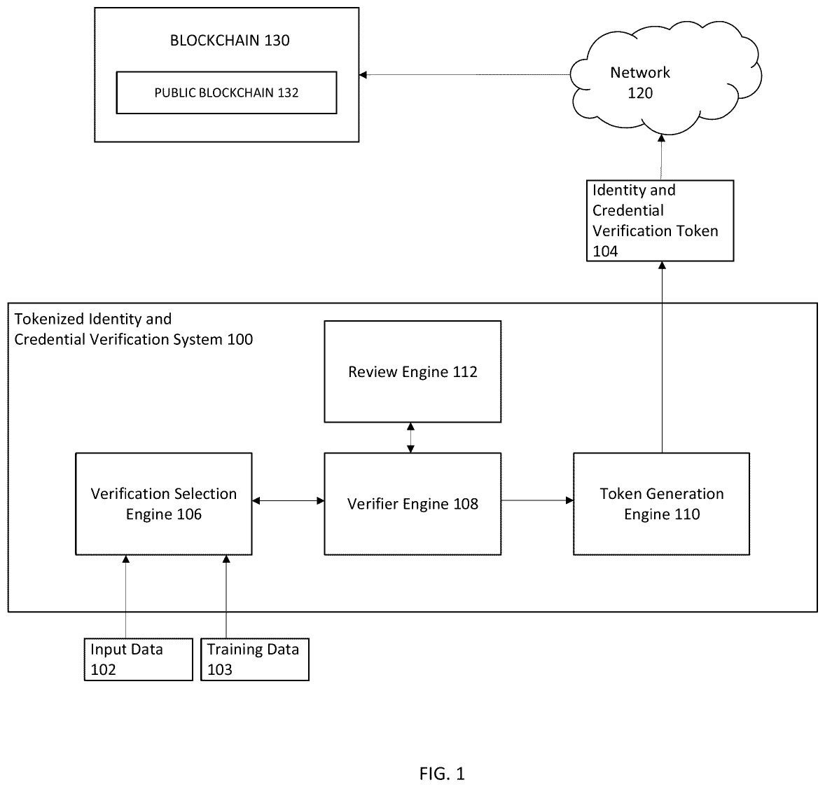

FIG. 1 depicts a block diagram of an example tokenized identity and credential verification system 100. Tokenized identity and credential verification system 100 may be implemented on one or more computing devices. Tokenized identity and credential verification system 100 may be configured to receive input data 102 for use in generating an identity and/or credential verification token. Tokenized identity and credential verification system 100 may receive input data 102 as part of a call to an API exposing tokenized identity and credential verification system 100 to one or more computing devices. Input data 102 may be provided to tokenized identity and credential verification system 100 through a non-transitory storage medium including remote storage connected to one or more computing devices over a network. Input data 102 may also be provided as input through a user interface on a client computing device coupled to tokenized identity and credential verification system 100.

Input data 120 may include data associated with the credentials of a user. The user may be any entity, such as an individual, group of individuals, company, etc. The credentials may include personal information and/or identity information of the entity, such as date of birth, social security number, educational history, employment history, affiliations, professional achievements, tax filing types, tax identification numbers associated with the companies, state of incorporation, etc. Input data 120 may also include portrait photographs, photographs of licenses, certifications, diplomas, etc., associated with the entity. Input data 120 may, in some instances, include any detailed information about authorities, universities, or employers that issued licenses, certifications, diplomas, etc., for the entity.

Input data 102 may also include data associated with identity verification such as personally identifiable information (PII) or data to determine which verification option to provide to a user for a response. Input data 102 may include mapping data to match verification options with actions requiring identity verification, such as account creation, account recovery, and/or account log-in.

Input data 102 may further include data specific to one or more verification options. Input data 102 may include social security numbers or any other types of personal historical information such as addresses, automobile color, automobile year, make, and model, business associations, phone numbers, income, home price, demographic information of the town where the user lives, etc. Input data 102 can also include specific types of personal information based on the purposes of identity verification. For example, for photo identification forensic analysis, input data 102 may include identity documents containing portrait photographs. For barcode data extraction, input data 102 may include identity documents containing a barcode such as driver licenses. For MRZ decoding, input data 102 may include identity documents containing machine-readable code, such as passports. For global watch list checks, input data 102 can include identity information included on global watch lists, such as names, addresses, dates of birth, height, weight, race, offense details, disposition, etc., for individuals on U.S. and foreign sanctions and watch lists, including the office of foreign assets control (OFAC), specially designated nationals (SDNs) and/or other lists like EU consolidated list, HM treasury sanctions, UN consolidated list, FBI most wanted, etc. For face and hand gesture recognition, input data 102 can include the faces and hands of individuals for identification. For thumb/fingerprint analysis, input data 102 can include thumbprints and/or fingerprints for identification. For two-step verification, input data 102 can include email addresses or phone numbers over which one-time passcodes are sent. For CVV/AVS credit/debit card verification, input data 102 can include card verification values and/or address verification values for credit cards and/or debit cards. For IP address lookup, input data 102 can include internet protocol addresses and/or location information of the IP addresses. For reverse phone number lookup, input data 102 can include mobile or landline phone numbers. It should be noted the foregoing input data and verification options are merely examples, and any input data for any verification option may be used.

Tokenized identity and credential verification system 100 may receive training data 103 for training one or more models for generating an identity and/or credential verification token. Training data 103 may correspond to a machine learning task for assisting in generating an identity and/or credential verification token, such as a task performed by a neural network to verify the identity and/or credentials of the user. The machine learning task may also include generating an identity and/or credentials verification token based on the historical data of the user and/or other users who possess similar educational levels, employment histories, and/or professional backgrounds.

Training data 103 can be in any form suitable for training a model, according to one of a variety of different learning techniques. Learning techniques for training a model can include supervised learning, unsupervised learning, and/or semi-supervised learning techniques. For example, training data 103 can include multiple training examples that can be received as input by a model. The training examples can be labeled with a desired output for the model when processing the labeled training examples. The label and the model output can be evaluated through a loss function to determine an error, which can be back propagated through the model to update weights for the model. For example, if the machine learning task is a classification task, the training examples can be images labeled with one or more classes categorizing subjects depicted in the images. As another example, a supervised learning technique can be applied to calculate an error between outputs, with a ground-truth label of a training example processed by the model. Any of a variety of loss or error functions appropriate for the type of task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

Tokenized identity and credential verification system 100 may be configured to output one or more identity and/or credential verification tokens 104 for the verified identity and/or credentials. Identity and credential verification token 104 may include a coded badge, such as of a certain color, shape, and/or symbol. A code, e.g., color, shape, and/or symbol, may correspond to the status of identity or credentials that need to be verified. For example, if the generated badge is red, the license associated with one of the identities or credentials to be verified is active and already verified. If the generated badge is gray, the license may have expired or become inactive. According to some examples, a different group of colors may be assigned according to different verification items or purposes, such as occupational licenses, professional certifications, and/or employment or education verification. For example, for occupational licenses, red, yellow, green, and gray badges may be used. For professional certifications, blue, orange, purple, and black badges may be used. For employment or education verification, gold, silver, and bronze badges may be used.

According to some examples, identity and credentials verification token 104 may be generated based on instructions associated with identity verification, such as confirming an identity, instructing that an alternative or additional identity verification step is needed, or instructing that an identity could not be verified. The output data may also include a confidence rating, liveness score and assessment, and/or facial recognition and correlation score pertaining to how well an identity could be verified based on one or more verification steps.

Identity and credentials verification token 104 may be generated in a variety of shapes. The shapes may include tetrahedron, octahedron, cube, icosahedron, or dodecahedron, as examples. A face of a shape may contain unique identities and credentials. For example, one face of a badge in a cubic shape may include information relating to the occupational license, and another face of the badge may include information relating to employment, educational information, date of birth, permanent addresses, etc. The shapes may be in a 3D format and a user may rotate the faces of the shapes to review the information contained in a face via a graphical user interface implemented on one or more user computing devices. Identity and credentials verification token 104 may be sent for display on a user display.

As another example, tokenized identity and credential verification system 100 may be configured to provide the identity and credential verification token 104 as output data as a set of computer-readable instructions such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement the functionality described herein, for example, as performed by a system, engine, module, or model. Tokenized identity and credential verification system 100 can further be configured to forward the output data to one or more other devices configured for translating the output data into an executable program written in a computer programming language and optionally as part of a framework for generating and displaying the credentials verification tokens for a user. Tokenized identity and credentials verification system 100 can also be configured to send identity and credential verification token 104 to a storage device for storage and later retrieval.

Tokenized identity and credential verification system 100 may include verification selection engine 106. Verification selection engine 106 may be implemented as one or more computer programs, specially configured electronic circuitry, or any combination thereof. Verification selection engine 106 may be configured to determine which information related to the user's credentials from input data 102 is to be verified. Verification selection engine 106 may receive, as input data 102, information that the user provides to tokenized identity and credential verification system 100. For example, if a user provides multiple copies of professional licenses or certifications, verification selection engine 106 may automatically select the copy that contains the most updated information or the farthest expiration date. Verification selection engine 106 may also preliminarily determine whether the received information contains invalid names of educational institutions or former employers. Verification selection engine 106 may determine the amount of information related to the credentials that are to be verified. For example, when verifying prior employment, the verification selection engine 106 may determine to verify the name of a former employer but not the physical address of the former employer. In other examples, when verifying professional certifications, verification selection engine 106 may determine to verify the name of the licensing entity but not the title of the professional license. Verification selection engine 106 may utilize a machine learning model trained on the training data 103 to determine which information is the most relevant information to select from input data 102.

Verification selection engine 106 may also be configured to determine which verification options to provide a user for verifying the identity of the user. Verification selection engine 106 can be configured to determine which verification options are relevant for the user based on the input data 102. For example, based on the input data 102, verification selection engine 106 can determine the relevant options to verify identity for account recovery can include knowledge-based quizzes and two-step verification. As another example, based on the input data 102, verification selection engine 106 can determine the relevant options to create a secure account can include SSN trace, photo identification forensic analysis, education, employment, and professional license verification, motor vehicle records, Department of Motor Vehicles, criminal background, and global watch list checks.

Tokenized identity and credential verification system 100 may further include verifier engine 108. Verifier engine 108 may be implemented as one or more computer programs, specially configured electronic circuitry or any combination thereof. Verifier engine 108 may be configured to verify the credentials selected by verification selection engine 106. Verifier engine 108 may be configured to be communicable with databases of the licensing authorities or certification providers. Verifier engine 108 may collect the information from the aforementioned authorities or certification providers to verify information selected by verification selection engine 106. For example, if verification selection engine 106 determines that the date of the issuance of a professional license needs to be verified, verifier engine 108 may receive other background information from verification selection engine 106 such as the name of the licensed user, the name of the licensing authority, etc. Verifier engine 108 may specifically collect the aforementioned information from the database of the licensing authority and compare the collected information with the information that verification selection engine 106 received. Verifier engine 108 may store the result of the comparison in any type of storage for later use as training data for a machine learning model. In some examples, verifier engine 108 may collect data from official licensing, certification, and educational databases to auto-populate much of the credentials that will be contained in credentials verification token 104. Verifier engine 108 may compare the auto-populated information with the information received from verification selection engine 106. In yet another example, institutional phone or email verification or physical document checks may be required to obtain the highest confidence levels from verifier engine 108.

Verifier engine 108 may also be configured to verify the identity of the user with the one or more verification options selected by verification selection engine 106. Verifier engine 108 can be configured to verify the identity of the user based on the input data 102 relevant to the one or more verification options. Verifier engine 108 can also be configured to determine whether additional verification is needed for identifying the user or determine whether the user cannot be identified with the one or more verification options. For example, verifier engine 108 can receive 5 answers to a 5-question knowledge quiz as input data 102. Verifier engine 108 can determine whether the answers are correct by comparing the answers to historical data received as input data 102. If all answers are correct, verifier engine 108 can verify the identity of the user. If some of the answers are correct, verifier engine 108 can determine whether an additional verification option is required. If minimal or no answers are correct, verifier engine 108 can determine the user cannot be verified.

Tokenized identity and credential verification system 100 may include review engine 112. Review engine 112 can be implemented as one or more computer programs, specially configured electronic circuitry or any combination of the preceding. Review engine 112 can be configured to assist a user with verifying their identity using conversational machine learning. For example, if verifier engine 108 determines an additional verification option is required or that the user cannot be verified, review engine 112 can be enabled to provide a user with additional verification options and/or walk the user through the verification options. If the user has any questions or problems with verifying, review engine 112 can use natural language processing and/or understanding to answer any queries from the user, which can be received as input data 102.

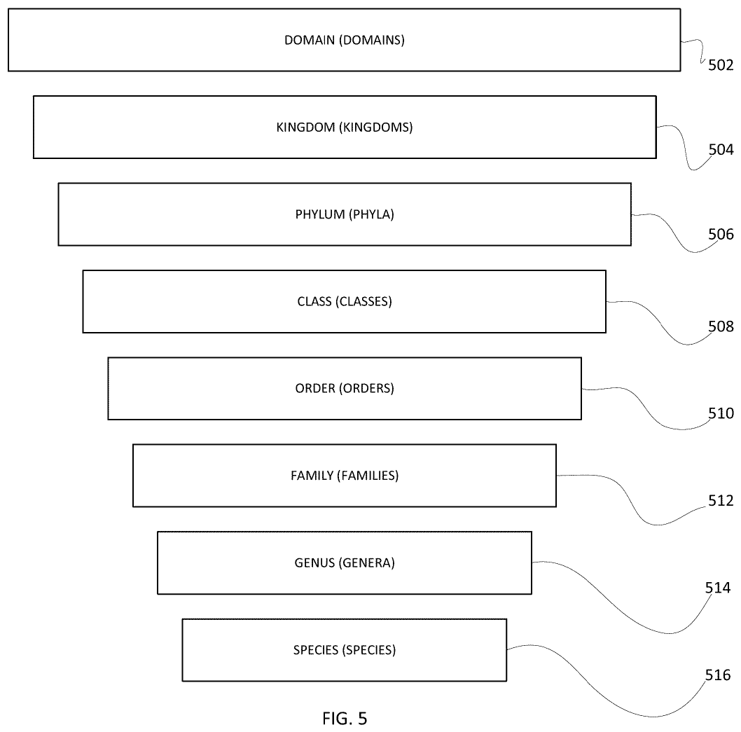

Tokenized identity and credential verification system 100 may include token generation engine 110. Token generation engine 110 may receive the verified identities and credentials from verifier engine 108. Token generation engine 110 may generate a token in the form of a virtual badge or medallion. According to some examples, token generation engine 110 may generate a badge or medallion of various colors, shapes, and/or symbols. A badge or medallion may contain multiple credentials related to one or more professional certifications or licenses or one or more identities of a user. A badge or medallion may have different colors, shapes, and/or symbols and/or be generated for display in a variety of shapes of geometry with multiple faces. For example, a face of a geometric shape may contain different identities or credentials in different colors. A color may represent the status of the licenses or certifications or the result or status of the verifiable identities of the user. Different colors and shapes of the badge or medallion are described in further detail in connection with FIGS. 5A-5B below.

Token generation engine 110 may generate identity and credential verification token 104 and send it to blockchain 130 via network 120. Blockchain 130 can include public blockchain 132. Public blockchain 132 may include a distributed database or ledger shared among nodes of a computer network. Blockchain 130 may be an immutable ledger that records transactions of credentials verification token 104 and tracks the transactions of identity and credentials verification token 104 via network 120. Transactions may include requests to receive identity and credentials verification token 104, such as from a user, a third party, or an audit request of authority. Public blockchain 132 may be a blockchain that any user may join and participate in the transactions via network 120. Any user may read, write, and/or audit the activities taking place in connection with identity and credentials verification token 104.

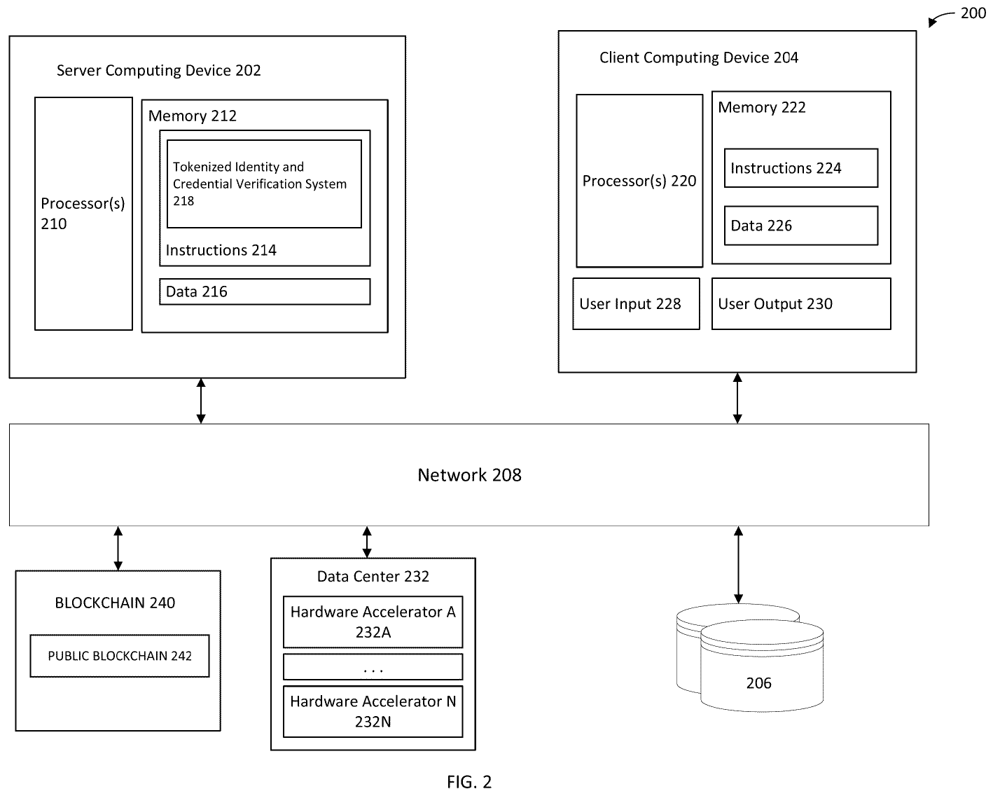

FIG. 2 depicts a block diagram of an example environment 200 for implementing a tokenized identity and credentials verification system. The tokenized identity and credentials verification system may be implemented in a server computing device 202 having one or more processors in one or more locations. The server computing device 202 can be communicatively coupled to a client computing device 204 as well as one or more storage devices 206 over a network 208.

Storage devices 206 can be a combination of volatile and non-volatile memory and can be at the same or different physical locations than the computing devices 202, 204. For example, storage devices 206 can include any type of non-transitory computer-readable medium capable of storing information, such as a hard drive, solid state drive, tape drive, optical storage, memory card, ROM, RAM, DVD, CD-ROM, write-capable, and read-only memories.

The devices 202, 204 may be capable of direct and indirect communication over network 208. For example, using a network socket, the client computing device 204 can connect to a service through an Internet protocol. The devices 202, 204 can set up listening sockets that may accept an initiating connection for sending and receiving information. The network 208 itself may include various configurations and protocols including the Internet, World Wide Web, intranets, virtual private networks, wide area networks, local networks, and private networks using communication protocols proprietary to one or more companies. The network 208 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 208, in addition or alternatively, can also support wired connections between devices 202, 204, including over various types of Ethernet connection.

Although a single server computing device 202 and client computing device 204 are shown in FIG. 2, it is understood that aspects of the disclosure can be implemented according to a variety of different configurations and quantities of computing devices, including in paradigms for sequential or parallel processing, or over a distributed network of multiple devices.

The server computing device 202 can include one or more processors 210 and memory 212. Memory 212 can store information accessible by processor 210, including instructions 214 that can be executed by processor 210. Memory 212 can also include data 216 that can be retrieved, manipulated, or stored by the processor 210. Memory 212 can be a type of non-transitory computer-readable medium capable of storing information accessible by the processors 210, such as volatile and non-volatile memory. The processor 210 can include one or more central processing units (CPUs), graphic processing units (GPUs), field-programmable gate arrays (FPGAs), and/or application-specific integrated circuits (ASICs).

The instructions 214 can include one or more instructions that, when executed by the processors 210, cause the one or more processors to perform actions defined by the instructions 214. The instructions 214 can be stored in object code format for direct processing by the processors 210, or in other formats including interpretable scripts or collections of independent source code modules that are interpreted on demand or compiled in advance. The instructions 214 can include instructions for implementing a tokenized identity and credentials verification system 218, which may correspond to tokenized identity and credentials verification system 100 of FIG. 1. Tokenized identity and credential verification system 218 can be executed using the processors 210, and/or using other processors remotely located from the server computing device 202.

The data 216 can be retrieved, stored, or modified by the processor 210 in accordance with instructions 214. The data 216 can be stored in computer registers, in a relational or non-relational database as a table having a plurality of different fields and records, or as JSON, YAML, proto, or XML documents. The data 216 can also be formatted in a computer-readable format such as, but not limited to, binary values, ASCII, or Unicode. Moreover, data 216 can include information sufficient to verify relevant credentials, such as numbers, descriptive text, proprietary codes, pointers, references to data stored in other memories, including other network locations, or information that is used by a function to calculate relevant data.

The client computing device 204 can also be configured similarly to the server computing device 202, with one or more processors 220, memory 222, instructions 224, and data 226. The client computing device 204 can also include a user input 228 and a user output 230. The user input 228 can include any appropriate mechanism or technique for receiving input from a user, such as a keyboard, mouse, mechanical actuators, soft actuators, touchscreens, microphones, and sensors.

The server computing device 202 can be configured to transmit data to the client computing device 204, and the client computing device 204 can be configured to display at least a portion of the received data on a display implemented as part of the user output 230. The user output 230 can also be used for displaying an interface between the client computing device 204 and the server computing device 202. The user output 230 can alternatively or additionally include one or more speakers, transducers or other audio outputs, a haptic interface or other tactile feedback that provides non-visual and non-audible information to the platform user of the client computing device 204.

Although FIG. 2 illustrates the processors 210, 220 and the memories 212, 222 as being within the computing devices 202, 204, components described herein can include multiple processors and memories that can operate in different physical locations and not within the same computing device. For example, some of instructions 214, 224 and the data 216, 226 can be stored on a removable SD card and others within a read-only computer chip. Some or all of the instructions and data can be stored in a location physically remote from, yet still accessible by, the processors 210, 220. Similarly, the processors 210, 220 can include a collection of processors that can perform concurrent and/or sequential operations. The computing devices 202, 204 can include one or more internal clocks providing timing information, which can be used for time measurement for operations and programs run by the computing devices 202, 204.

The server computing device 202 and the client computing device 204 can be connected over network 208 to a data center 232, which can house any number of hardware accelerators 232A-N. The data center 232 can be one of multiple data centers or other facilities in which various types of computing devices are located. Computing resources housed in the data center 232 can be specified for deploying machine learning models related to identity verification as described herein.

The server computing device 202 can be configured to receive requests to process data from the client computing device 204 on computing resources in the data center 232. For example, environment 200 can be part of a computing platform configured to provide a variety of services to users, through various user interfaces and/or application programming interfaces (APIs) exposing the platform services. The variety of services can include verifying the credentials of the user. The client computing device 204 can transmit input data. Tokenized identity and credentials verification system 218 can receive the input data, and in response, generate identity and credential verification tokens.

Tokenized identity and credential verification system 218 can maintain a variety of machine learning models in accordance with different constraints available at the data center 232. For example, the server computing device 202 can maintain different families for deploying machine learning models on various types of processors and/or GPUs housed in the data center 232 or otherwise available for processing.

One or more machine learning models can be deployed in a data center 232 housing a hardware accelerators 232A-N on which the deployed machine learning models will execute for verifying credentials. The hardware accelerators 232A-N can be any type of processor, such as a CPU, GPU, FPGA, or ASIC.

An architecture of the machine learning model can refer to characteristics defining the model, such as characteristics of layers for the model, how the layers process input, or how the layers interact with one another. For example, the model can be a convolutional neural network (ConvNet) that includes a convolution layer that receives input data, followed by a pooling layer, followed by a fully connected layer that generates a result. The architecture of the model can also define the types of operations performed within each layer. For example, the architecture of a ConvNet may define that rectified linear unit (ReLU) activation functions are used in the fully connected layer of the network. Any model architecture can be generated that can output results associated with verifying the credentials.

The one or more machine learning models can include statistical models, propensity scoring models, regression discontinuity models, classification models, potential outcomes models, quasiperiodic models, fractal models, and/or large language models or other large generative models, such as neural networks, convolutional neural networks, or deep neural networks, which can all be used in combination or in part for verifying identity and credentials of a user.

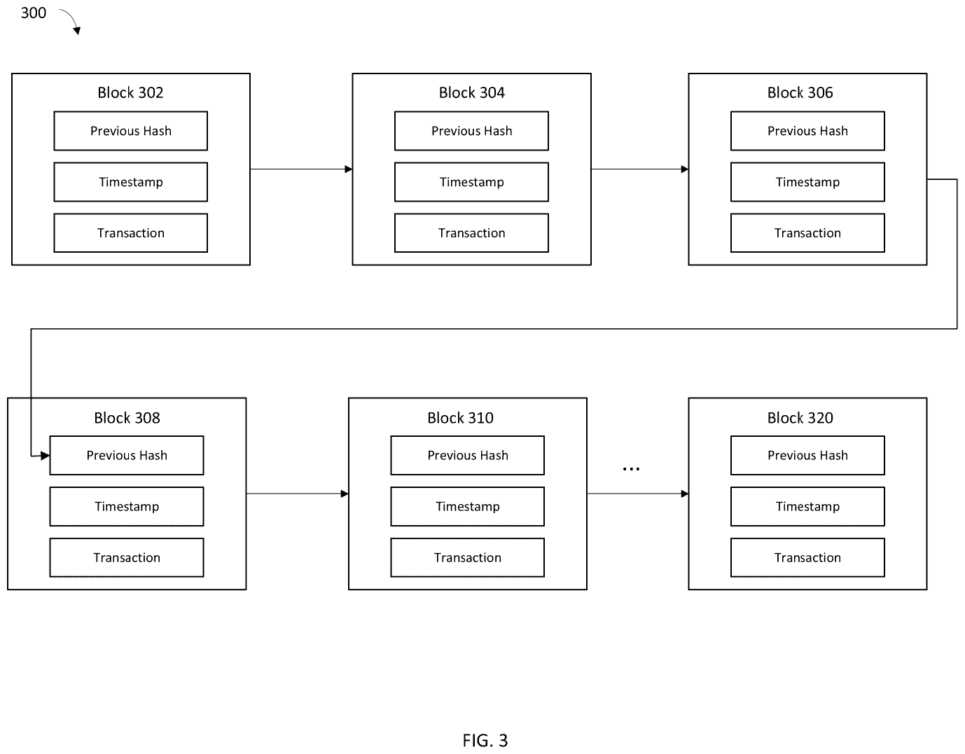

Server computing device 202 may generate identity and credential verification token and send the token to blockchain 240 via network 208. Blockchain 240 can include public blockchain 242. Public blockchain 242 may include a distributed database or ledger shared among nodes of a computer network. Blockchain 240 is discussed in more detail with respect to FIG. 3 below.

FIG. 3 depicts a block diagram illustrating example blockchain blocks. Blockchain 300 may comprise blocks 302-320. Blocks 302-320 may include previous hash, timestamps, and transactions. A block may be generated and appended to a preceding block using blockchain technologies such as proof of work, proof of stake, and/or principal Byzantine fault tolerance. Proof of work techniques may be used to validate each transaction associated with the verification of the credentials of a user. For example, if a user wants to add new credentials such as new educational degrees or certificates, one party may need to prove to others that a certain amount of a specific computation effort such as solving a computation puzzle (i.e. mining). Proof of stake technique may be used to verify the new credentials that the user wants to add. Validators who are chosen based on the number of stakes in the blockchain may determine whether the new credentials may be added as a new block. The Byzantine Fault Tolerance technique may be used to safeguard against system failures caused by certain fraudulent, incorrect, or faulty credential information added as blocks by employing a mechanism that can keep the system functioning correctly as long as two-thirds of the blockchain network agree or reach consensus. A block may be sequentially appended to blockchain 300 in increasing order of the timestamp in which each block is created and appended to blockchain 300. The timestamp of each block may include the timestamp value at which each block was created and appended to blockchain 300. A previous hash of each block may contain the hash of the adjacent block preceding each block. The previous hash may provide the information that links the preceding block to the current block. For example, the previous hash of block 306 may be generated based on the information that block 304 contains, and thus, the previous hash of block 306 may act as an immutable link between block 306 and block 304. Block 302 may be the first block, which may be referred to as a genesis block. A transaction stored in each block may contain information related to the generated identity and credentials verification token and how the generated identity and credentials verification token may have been used by different users or entities. Blockchain 300 may be tamper-proof because of its decentralized nature, cryptographic security, and immutability, and thus, any record pertaining to the activities in connection with the identity and credentials verification token may not be changed or deleted, thereby making credentials verification tokens highly transparent and trustworthy.

Moreover, since blockchain 300 may be distributed across many nodes over the network, no single entity or node may control or maintain the information related to the identity and credentials verification token. An identity and credentials verification token may be given a unique identity that is exclusively associated with that identity. That is, an identity and credential verification token may have a unique color, shape, and/or symbol as well as a unique set of identities or credentials. Blocks 302-320 may also include metadata linked to an identity and credential verification token such as name, birthdate, photos, accomplishments, and other attributes. Such metadata may further ensure the verifiability of the identity and credential verification token. A transaction included in each of blocks 302-320 may be permanently recorded on blockchain 300, thereby providing an audit trail that may provide a historical log of activities in connection with each identity and credentials verification token with transparency and accountability.

Blockchain 300 may employ strong cryptography to generate a hash for each block and a consensus mechanism to secure all records and transactions without needing a central authority. Such features may allow identity and credentials verification tokens to be created in a permissionless manner by any user. Further, since blockchain-based identity and credentials tokens may be recognized across different platforms, systems, and applications, blockchain 300 may make the identity and credentials verification token portable and compatible with any decentralized and open-nature platform. Generating a new block in blockchain 300 requires resources, time, and consent of every other user, and thus it may be difficult to generate a new identity and credentials verification token in blockchain 300.

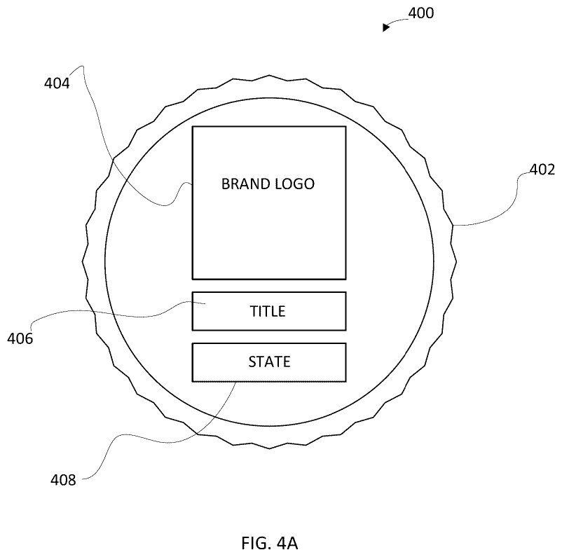

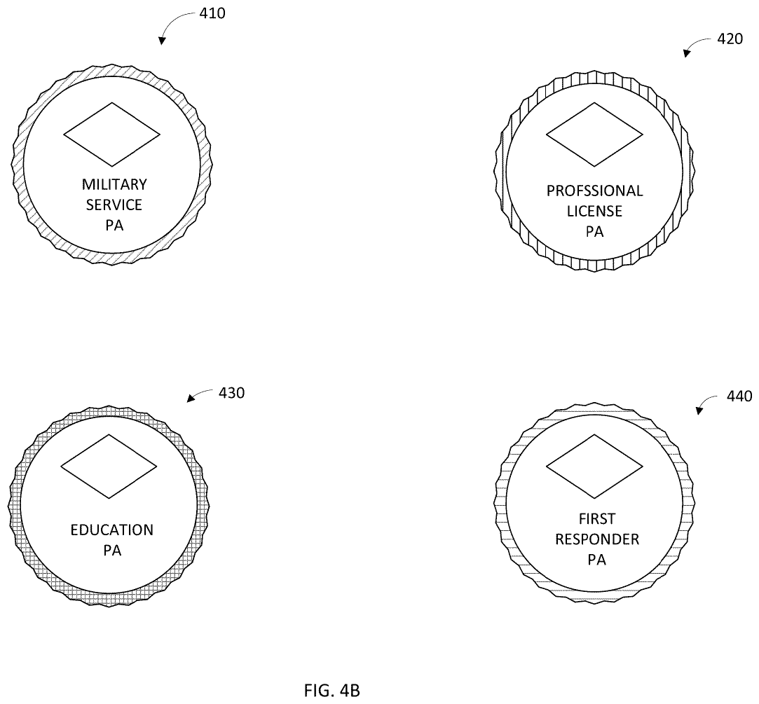

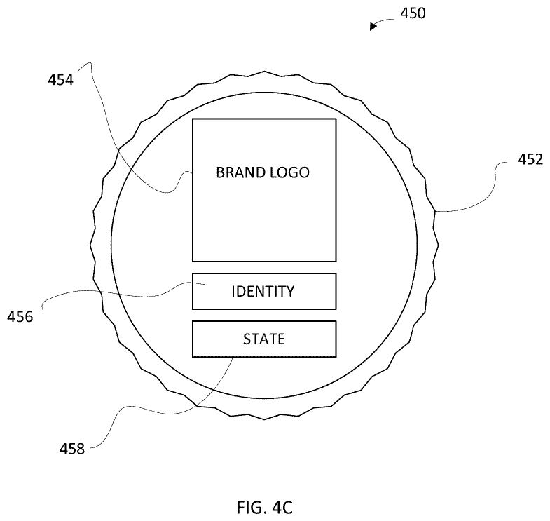

FIGS. 4A-4B depict diagrams illustrating example credentials verification tokens according to aspects of the disclosure. FIG. 4A depicts an example credential badge 400. Badge 400 may include brand logo 404, title 406, and state 408. Outer circle 402 may indicate a color corresponding to the status of a credential. Brand logo 404 may include a brand logo of a company that generates and provides badge 400. Title 406 may include the verified credentials that are certified by a company or organization. State 408 may include the name of the state where the title 406 was issued.

According to some examples, a coded badge may be generated for verifying various credentials such as occupational licenses, professional certifications, and/or employment or education verification. Credentials may be assigned to a different set of colors. For example, with respect to occupational licenses, a red badge may indicate active and verified licenses in good standing, and thus it indicates that an individual is currently licensed and authorized to practice in that occupation. A yellow badge may indicate that an individual is in the process of renewing an active license A green badge may indicate that an individual is working to renew an expired but previously active license. A gray badge may indicate that an individual once held a license, but it is now expired and not being renewed.

With respect to professional certifications, a blue badge may indicate that an individual currently holds a valid professional certification. An orange badge may indicate that renewal of an active certification is in progress. A purple badge may indicate that an individual is renewing an expired but previously active certification. A black badge may indicate that an individual once held a certification, but it is now expired and not being renewed.

With respect to employment and/or education verification, a gold badge may indicate that a claimed employer, degree, institution, etc., of a user has been verified as legitimate, and that the user remains in good standing. A silver badge may indicate that some information related to a claimed employer, degree, institution, etc., of a user could not be verified and thus, further evidence may be needed before full verification can be made. For instance, information corresponding to a claim that an individual is a graduate of a particular college may include a start date and an end date of the individual attending the college but may not include confirmation that a degree was conferred. A bronze badge may indicate that claimed employers, degrees, institutions, etc. of a user could not be verified and may be fraudulent or misleading. According to some examples, unverified or fraudulent claims may be flagged with silver, bronze, and gray badges to warn other users of potentially misleading information from an individual. Any color or combinations of colors or other coding, e.g., shapes or symbols, may be used to indicate various statuses of any type of credentials that can be verified.

FIG. 4B depicts various examples of colored badges. Badge 410 may be a green badge (illustrated with diagonal patterns representing the green color) indicating the occupation of a user. The user is working in military service and the related credentials were verified in Pennsylvania (PA). The green color indicates that the user is in the process of renewing the relevant license associated with military service. Badge 420 may be a purple badge (illustrated with vertical patterns representing the purple color) generated for the verified professional license. The license was certified in PA. The purple color indicates that the user is also renewing the expired professional license. Badge 430 may be a yellow badge (illustrated with grid patterns representing the yellow color) indicating a professional license associated with education. The license was certified in PA. The yellow color indicates that the user is in the process of renewing the license associated with education. Badge 440 may be a red badge (illustrated with horizontal patterns representing the red color). The occupation of the user is the first responder. The red color indicates that the user is currently licensed and authorized to practice in the aforementioned occupation.

FIG. 4C depicts an example identity verification badge 450. Badge 450 may include brand logo 454, identity 456, and state 458. Outer circle 452 may indicate a color corresponding to the status of an identity verification. Brand logo 453 may include a brand logo of a company that verifies the identity of a user. Identity 456 may include the identity of a user based on a combination of information such as name, date of birth, height, weight, driver's license, portrait photograph, etc. Badge 450 may display the status of the identity verification such as confidence rating, liveness score and assessment, and facial recognition and correlation score pertaining to how each of the above identities has been verified. For example, when the liveliness or correlation score of the identity verification using facial recognition is a little less than 100% (e.g. 50%˜ 70%) outer circle 452 may display yellow color. In other examples, state 458 may provide a link that other users can click to obtain detailed information as to the methods or documents used to verify the identity. Badge 450 may be displayed to authenticate the identity of a user when the user attempts to post a message to an SNS thread or reply to questions posted by other users.

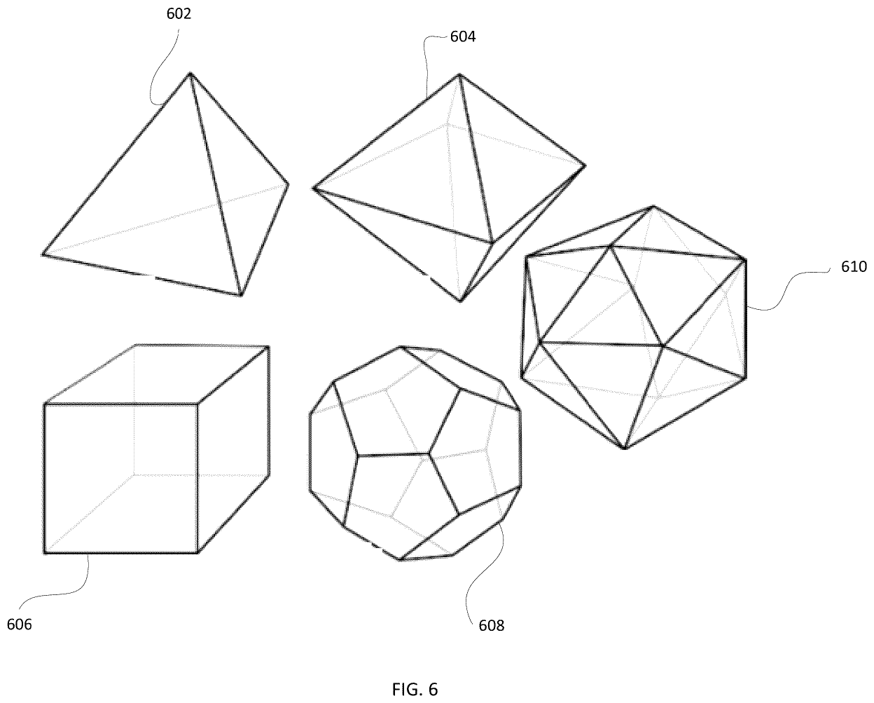

FIG. 5 depicts a block diagram illustrating example taxonomy structures. According to some examples, identities and/or credentials may be organized according to various levels of taxa, e.g., eight levels as illustrated in FIG. 5. The eight levels of taxa may include domain 502, kingdom 504, phylum 506, class 508, order 510, family 512, genus 514, and species 516. Domain 502 may be the highest level of taxa. Kingdom 504 may include a high-level category within the domain 502. Phylum 506 may include a major branch within the kingdom 504. Class 508 may include subdivisions within a phylum 506. Order 510 may include further subdivision within class 508. Family 512 may include a group of closely related order 510 within class 508. Genus 514 may include a smaller group within family 512. Species 516 may include the most specific taxonomic category. According to some examples, the identities and/or credentials may be subdivided into subgroups in hierarchical order and may be assigned to one or more faces of the identity and credentials verification tokens illustrated in FIG. 6 below. For example, a medical doctor's credentials may be subdivided and assigned to each of the eight levels of taxonomy described above. Domain 502 may indicate a healthcare industry, and kingdom 504 may represent an occupation (i.e. medical doctor). Phylum 506 may represent a particular practice area of the medical doctor (e.g. family medicine, orthopedics, internalist, etc.) Class 508 may represent specific training the medical doctor received. Order 501 may represent years of practice. Family 512 may represent locations of practice Genus 514 may represent any other recognition or achievements related to the particular practice area. Species 516 may represent the history of patients' complaints or reviews. According to some examples, the above category level of identity or verification information may be manually selected by a user when generating the identity and credential verification token.

FIG. 6 depicts diagrams illustrating various shapes of identity and credential verification tokens. The identity and credential verification token may be generated using shapes such as tetrahedron 602, octahedron 604, cube 606, dodecahedron 608, and icosahedron 610. It is to be understood that the identity and credential verification token may be in the form of any other type of geometry shape. A shape may have a different number of surfaces, edges, and vertices. Faces, edges, and vertices may include different levels of credentials. For example, tetrahedron 602 may have four faces, six edges, and four vertices. Octahedron 604 may include eight surfaces, twelve edges, and six vertices. Icosahedron 610 may include twenty faces, thirty edges, and twelve vertices. Dodecahedron 608 may include twelve faces, thirty edges, and twenty vertices. Cube 606 may include six faces, twelve edges, and eight vertices.

According to some examples, each identity and credentials verification token generated in one of the above-described geometry shapes may be provided as a 3D token to other users. Each face of the geometry shape may contain different levels of categories of information. For example, the first face may include the credentials categorized into a domain, the second face may include the identity and/or credentials categorized into a kingdom, etc. Each edge may be presented in a different color in accordance with the status of the credentials being verified. According to some examples, a user may manually modify or adjust the level of information to be included in each face and the shape of the identity and credentials verification token.

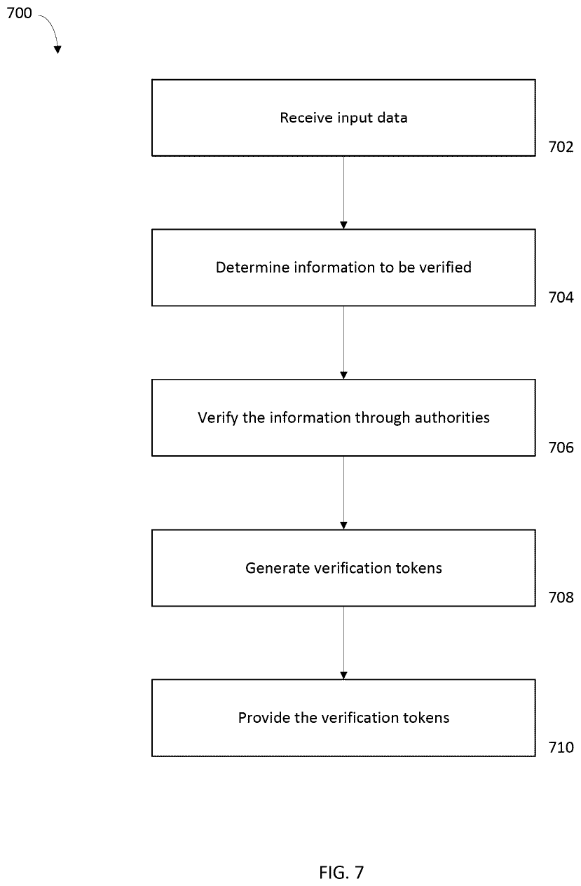

FIG. 7 depicts a flow diagram of an example credentials verification process 700. The example process can be performed on a system of one or more processors in one or more locations, such as the tokenized identity and credential verification system 100 of FIG. 1. According to block 702, the tokenized identity and credential verification system may receive input data. Input data may include any form of information related to credentials that need to be verified. Such information may include personal information, professional certificates, and/or licenses of a user.

According to block 704, the tokenized identity and credentials verification system may determine the information to be verified. For example, the input data received in the preceding step may include irrelevant information and the tokenized identity and credential verification system may need to exclude the irrelevant information and distinguish relevant information from the irrelevant information. The tokenized identity and credential verification system may utilize a machine learning model to distinguish the relevant information from the irrelevant information.

According to block 706, the tokenized identity and credential verification system may verify the information using information collected from databases of licensing authorities. For example, the tokenized identity and credential verification system may search the same copies of the professional certificates or licenses stored in the databases to compare with the information provided by the user. If the copies discovered by the tokenized identity and credential verification system are identical to the copies provided by the user, the credentials contained in the certificate or license are verified.

According to block 708, the tokenized identity and credential verification system may generate a credential verification token once the above credentials have been verified. For example, the credential verification token may include a company name that verified the credentials, a coding representing the status of the credentials, the name of the certification or license, and/or the place where the certification or license was issued.

According to block 710, the tokenized identity and credentials verification system may record the generated credentials verification token in a newly generated block in a blockchain. The new block may be generated using one or more proof of work, proof of stake, and/or principal Byzantine fault tolerance. Any user may request a retrieval of the credentials verification token and review the associated credentials contained in the credential verification token. Any activities associated with the credential verification token may be recorded in every block of the blockchain.

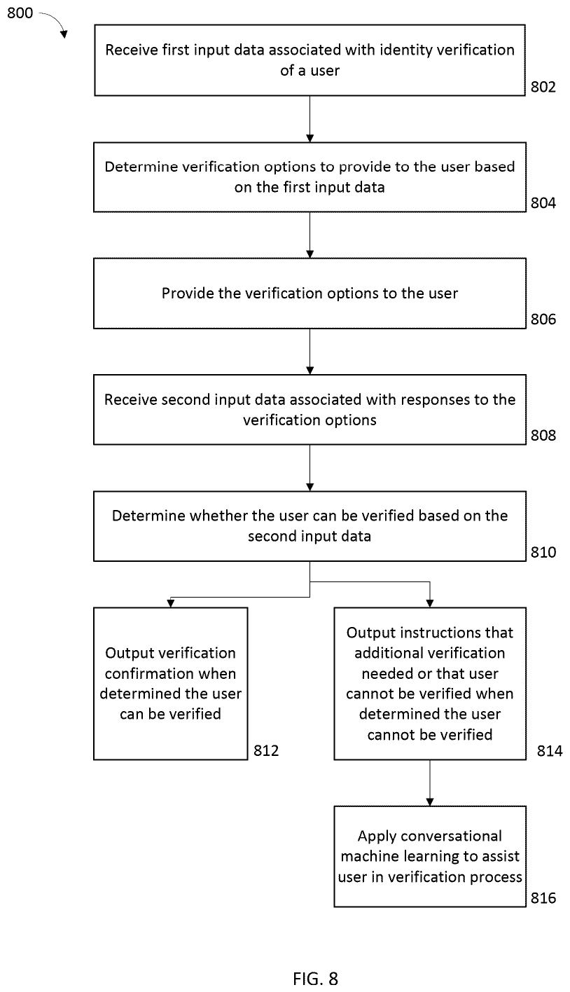

FIG. 8 depicts a flow diagram of an example identity verification process 800. The example process 800 can be performed on a system of one or more processors in one or more locations, such as the automatic verification system 100 of FIG. 1.

According to block 802, the tokenized identity and credential verification system can receive first input data, including data associated with the identity verification of a user. The first input data can correspond to data indicating an initiation of identity verification, such as initial identity information. The initial identity information can include personal identification information, a username, and/or a password. The first input data can also include data indicating the purpose of the identity verification, such as account creation, account recovery, and/or consent capture.

According to block 804, the tokenized identity and credential verification system can determine verification options to provide to the user based on the first input data. The tokenized identity and credential verification system can match verification options with the initial identity information and what the verification is needed for. For example, based on the first input data, the tokenized identity and credentials verification system can determine the verification options to provide to the user for account recovery are knowledge-based quizzes and two-step verification.

According to block 806, the tokenized identity and credential verification system can provide verification options to the user.

According to block 808, the tokenized identity and credential verification system can receive second input data associated with responses to the provided verification options. The second input data can correspond to data for determining the credibility of the provided verification options. The second input data can include user-provided responses to the provided verification options as well as historical data from repositories for comparison with the user-provided responses.

According to block 810, the tokenized identity and credential verification system can determine whether the user can be verified based on the second input data. The tokenized identity and credential verification system can compare user-provided responses to one or more verification options with historical data from repositories to determine the accuracy of the user-provided responses. For example, the tokenized identity and credential verification system can compare answers to questions of a knowledge quiz with historical data to determine their accuracy. If a first threshold amount of user-provided responses is determined to be accurate, the tokenized identity and credential verification system can verify the user. If a second threshold amount of user-provided responses less than the first threshold is determined to be accurate, the tokenized identity and credential verification system can determine whether additional verification is needed. If the user-provided responses that are determined to be accurate are below the second threshold amount, the tokenized identity and credential verification system can determine the user cannot be verified.

According to block 812, when the tokenized identity and credential verification system determines the user can be verified, the tokenized identity and credential verification system can output a verification confirmation to the user.

According to block 814, when the tokenized identity and credential verification system determines additional verification is needed or the user cannot be verified, the tokenized identity and credential verification system can output instructions indicating the additional verification or that verification could not be performed.

According to block 816, the tokenized identity and credential verification system can apply a conversational machine learning model to assist the user in the verification process. The conversational machine learning model can answer any questions or resolve any issues the user is having with the verification process using natural language processing and/or understanding. The conversational machine learning model can provide the user with additional verification options and/or assist the user with the provided verification options.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

The phrase “configured to” is used in different contexts related to computer systems, hardware, or part of a computer program. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program is said to be configured to perform one or more operations, this means that the computer program includes one or more program instructions, that when executed by one or more computers, causes the one or more computers to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for maintaining an identity and credential verification token, comprising:
determining, by one or more processors, based on one or more visible statuses of a coded digital badge representing the identity and credential verification token, that at least one of an identity or one or more credentials of a user needs to be verified;
providing, by the one or more processors, one or more verification options to a user device for verifying the at least one of an identity or one or more credentials of the user;
receiving, by the one or more processors, data associated with responses to the one or more verification options;
receiving, by the one or more processors, data associated with information for verifying the responses to the one or more verification options;
verifying, by the one or more processors, the responses by comparing the data associated with the responses to the one or more verification options with the data associated with the information for verifying the responses; and
updating, by the one or more processors, the one or more visible statuses of the coded digital badge, in response to verifying the responses.

2. The method of claim 1, further comprising providing, by the one or more processors, information indicating a purpose for verifying the identity or credentials of the user on the identity and credential verification token.

3. The method of claim 1, wherein the responses are verified when a difference between the data associated with the responses to the one or more verification options and the data associated with the information for verifying the responses is within a pre-configured threshold range of similarity.

4. The method of claim 1, further comprising determining, by the one or more processors, accuracy of the data associated with the responses to the one or more verification options based on historical data of the user.

5. The method of claim 1, further comprising outputting, by the one or more processors, a verification confirmation to the user in response to generating the identity and credential verification token.

6. (canceled)

7. The method of claim 1, further comprising:
determining, by the one or more processors, the responses cannot be verified; and
outputting, by the one or more processors, a notification in response to determining the responses cannot be verified.

8. The method of claim 1, further comprising:
determining, by the one or more processors, the identity and credentials verification token is fraudulent; and
flagging, by the one or more processors, the identity and credentials verification token, in response to determining the identity or credentials is fraudulent.

9. The method of claim 1, wherein the one or more credentials are related to at least one of occupational licenses, professional certifications, employment verification, or education verification.

10. The method of claim 1, wherein receiving the data associated with information for verifying the responses further comprises automatically collecting the data associated with information for verifying the responses from at least one of licensing certification or educational databases.

11. The method of claim 1, wherein verifying the data further comprises using a conversational machine learning model to assist the user with verifying the responses through natural language processing.

12. The method of claim 1, wherein generating the credential verification token further comprises generating different shapes for the credential verification token based on levels of taxonomy.

13. The method of claim 1, further comprising distributing, by the one or more processors, the identity and credential verification token in a blockchain.

14. The method of claim 1, wherein the one or more verification options include knowledge-based quizzes, photo identification forensic analysis, or multi-factor authentication.

15. A system comprising:
one or more processors; and
one or more storage devices coupled to the one or more processors and storing instructions that, when executed by the one or more processors, cause the one or more processors to:
determine, based on one or more visible statuses of a coded digital badge representing the identity and credential verification token, that at least one of an identity or one or more credentials of a user needs to be verified;
provide one or more verification options to a user device for verifying the at least one of an identity or one or more credentials of the user;
receive data associated with responses to the one or more verification options;
receive data associated with information for verifying the responses to the one or more verification options;
verify the responses by comparing the data associated with the responses to the one or more verification options with the data associated with the information for verifying the responses; and
update the one or more visible statuses of the coded digital badge, in response to verifying the responses.

16. The system of claim 15, wherein the instructions cause the one or more processors to provide information indicating a purpose for verifying the identity or credentials of the user on the identity and credential verification token.

17. The system of claim 15, wherein the responses are verified when a difference between the data associated with the responses to the one or more verification options and the data associated with the information for verifying the responses is within a pre-configured threshold range of similarity.

18. The system of claim 15, wherein the instructions cause the one or more processors to output a verification confirmation to the user in response to generating the identity and credential verification token.

19. (canceled)

20. A non-transitory computer-readable medium for storing instructions that, when executed by one or more processors, cause the one or more processors to perform the method comprising:
providing one or more verification options to a user device for verifying at least one of an identity or one or more credentials of a user;
receiving data associated with responses to the one or more verification options;
receiving data associated with information for verifying the responses to the one or more verification options;
verifying the responses by comparing the data associated with the responses to the one or more verification options with the data associated with the information for verifying the responses; and
generating the identity and credential verification token based on coding the verified information using a coded digital badge, in response to verifying the responses.
